(19) United States
(12) Patent Application Publication
(10) Pub. No.: US 2025/0117227 A1
(43) Pub. Date: Apr. 10, 2025

(54) METHOD FOR ADJUSTING APPLICATION SETTINGS AND ELECTRONIC DEVICE

(71) Applicant: MEDIATEK INC., Hsinchu City (TW)

(72) Inventors: Ching-Yeh CHEN, Hsinchu City (TW); Yi-Wei HO, Hsinchu City (TW); Te-Hsin LIN, Hsinchu City (TW); Shih-Ting HUANG, Hsinchu City (TW); Chung Hao HO, Hsinchu City (TW); Yu-Hsien LIN, Hsinchu City (TW); Chiu-Jen LIN, Hsinchu City (TW); Cheng-Che CHEN, Hsinchu City (TW)

(21) Appl. No.: 18/645,738

(22) Filed: Apr. 25, 2024

Related U.S. Application Data
(60) Provisional application No. 63/588,308, filed on Oct. 6, 2023.

(51) Int. Cl. G06F 9/445; G06F 11/30; G06F 11/34

(52) U.S. Cl. CPC G06F 9/44505; G06F 11/3058; G06F 11/3466

(57) ABSTRACT

A method for adjusting application settings is provided. The method includes using an application setting module to receive at least one performance target from an application running on an electronic device. The method further includes using the application setting module to record at least one performance indicator of the application while the application is running, wherein the performance indicator corresponds to the performance target. The method further includes using the application setting module to estimate the estimated time that the temperature of the electronic device sustains less than the defense temperature. The method further includes using the application setting module to determine the score according to the performance indicator and the estimated time, wherein the score indicates to the application that it should raise, lower, or keep a current setting.

### CROSS REFERENCE TO RELATED APPLICATIONS

This application claims priority of U.S. Provisional Application Ser. No. 63/588,308, filed on 2023 Oct. 6, the entirety of which is incorporated by reference herein.

### BACKGROUND OF THE INVENTION

### Field of the Invention

The present invention relates to an application setting adjustment method, and, in particular, it relates to a method which automatically adjusts settings.

### Description of the Related Art

Users usually operate their applications under the default settings established by the application developers. However, these default settings may not be suitable for every device and every user. If the settings are too high, the device may suffer from excessive loading, which causes lags, frame rate jitters, or overheating. On the other hand, if the settings are too low, the full potential of the device may not be utilized. In each case, the user experience is negatively affected. Thus, determining appropriate application settings is pivotal to the user experience.

Some developers may determine different settings for different devices and platforms. However, this requires a lot of resources for testing to determine the appropriate settings for each device and platform. Moreover, the settings may still not be suitable for every user. Other developers may use same settings for different devices and platforms and let users adjust the settings on their own. However, this requires that users understand the abilities and performance of the platform. It is difficult for a user without the relevant knowledge to find the appropriate settings by manually adjusting the settings.

Thus, a method for automatically finding appropriate settings is required.

### BRIEF SUMMARY OF THE INVENTION

An embodiment of the present invention provides a method for adjusting application settings. The method includes using an application setting module to receive at least one performance target from an application running on an electronic device. The method further includes using the application setting module to record at least one performance indicator of the application while the application is running, wherein the performance indicator corresponds to the performance target. The method further includes using the application setting module to estimate the estimated time that the temperature of the electronic device sustains less than a defense temperature. The method further includes using the application setting module to determine the score according to the performance indicator and the estimated time, wherein the score indicates to the application that it should raise, lower, or keep a current setting.

An embodiment of the present invention provides an electronic device. The electronic device includes a memory and a processor. The memory is configured to store at least one program. The processor is configured to drive the program to implement an application and an application setting module. The application setting module is configured to receive at least one performance target from the application. The application setting module is further configured to record at least one performance indicator of the application while the application is running. The performance indicator corresponds to the performance target. The application setting module is further configured to estimate the estimated time that the temperature of the electronic device sustains less than the defense temperature. The application setting module is further configured to determine the score according to the performance indicator and the estimated time, wherein the score indicates to the application that it should raise, lower, or keep a current setting.

### BRIEF DESCRIPTION OF THE DRAWINGS

The present invention can be more fully understood by reading the subsequent detailed description and examples with references made to the accompanying drawings, wherein:

FIG. 1 is a block diagram of an electronic device in accordance with the embodiments of the present disclosure;

FIG. 2 is a flow diagram of a method for adjusting application settings in accordance with the embodiments of the present disclosure;

FIG. 3 is a flow diagram of a method for determining the estimated time in accordance with the embodiments of the present disclosure; and

FIG. 4 is an illustration of a table in accordance with the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

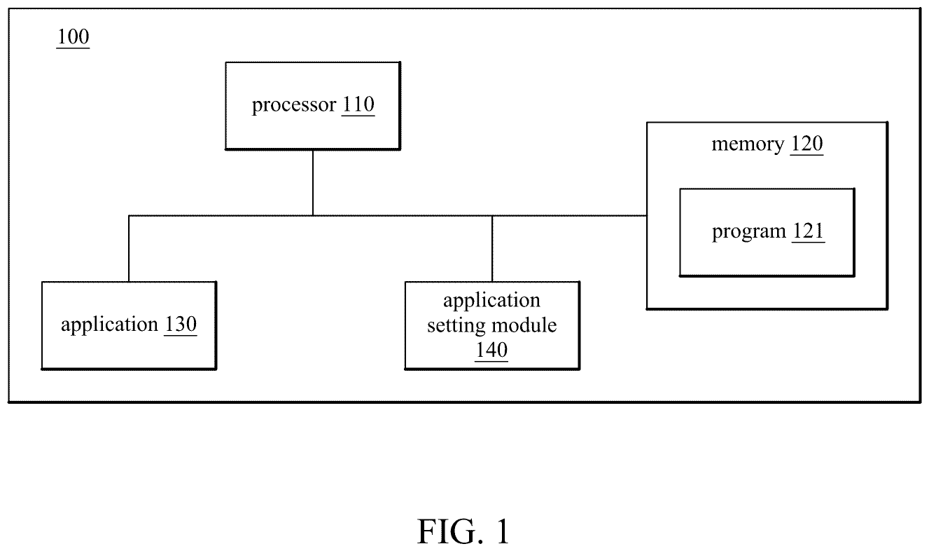

FIG. 1 is a block diagram of an electronic device 100 in accordance with the embodiments of the present disclosure. The electronic device 100 may perform various functions to implement processes and methods described herein, such as methods for adjusting application settings in accordance with embodiments of the present disclosure. In some embodiments, the electronic device 100 may be a mobile apparatus, a wearable apparatus, or a computing apparatus. For example, the electronic device 100 is a smartphone, a tablet computer, a notebook computer, a desktop computer, or a smartwatch. The electronic device may be implemented in the form of one or more integrated-circuit (IC) chips such as one or more processors. The electronic device 100 includes a processor 110, a memory 120.

The processor 110 controls operations of the electronic device 100. The processor 110 provides the required process ability to perform operating systems, programs, software, modules, applications, and functions of the electronic device 100. In some embodiments, processor 110 may be implemented in the form of hardware with electronic components, such as transistors, diodes, capacitors, resistors, or inductors. These components are configured and arranged to achieve specific purposes in accordance with the present disclosure. The processor 110 may include one or more processing units. For example, the processor 110 may include a general purpose micro-processor, a central processing unit (CPU), an application processor, a graphics processing unit (GPU), an image signal processor, a controller, a digital signal processor, and/or related chip set. Different processing units may be independent components, or may be integrated into other processing units.

The memory 120 stores data required by the processor 110. The memory 120 may include non-volatile memories, such as read only memory (ROM) and flash memory. The memory 120 may also include volatile memories, such as dynamic random access memory (DRAM) and static random access memory (SRAM). In some embodiments, the memory 120 stores at least one program 121 (e.g. computer-readable instruction). The program 121 can be read by the processor 110. When the program 121 is operated by the processor 110, the program 121 causes the processor 110 to implement methods according to the embodiments of the present disclosure.

The processor 110 drives the program 121 to implement an application 130 and an application setting module 140. In some embodiments, the application 130 and the application setting module 140 are software modules performed by the processor 110. For example, the application 130 may be, but not limited to, a game application, a live stream application, or a video application. The application 130 has at least one adjustable setting, such as frame rate, graphic quality, visual effects, particle effects, and filters.

Moreover, the electronic device 100 may include other components, which are not shown in FIG. 1. In some embodiments, the electronic device 100 further include a temperature sensor, a display, a touch screen, an user interface device (e.g. mouse and keyboard), or an internal power supply.

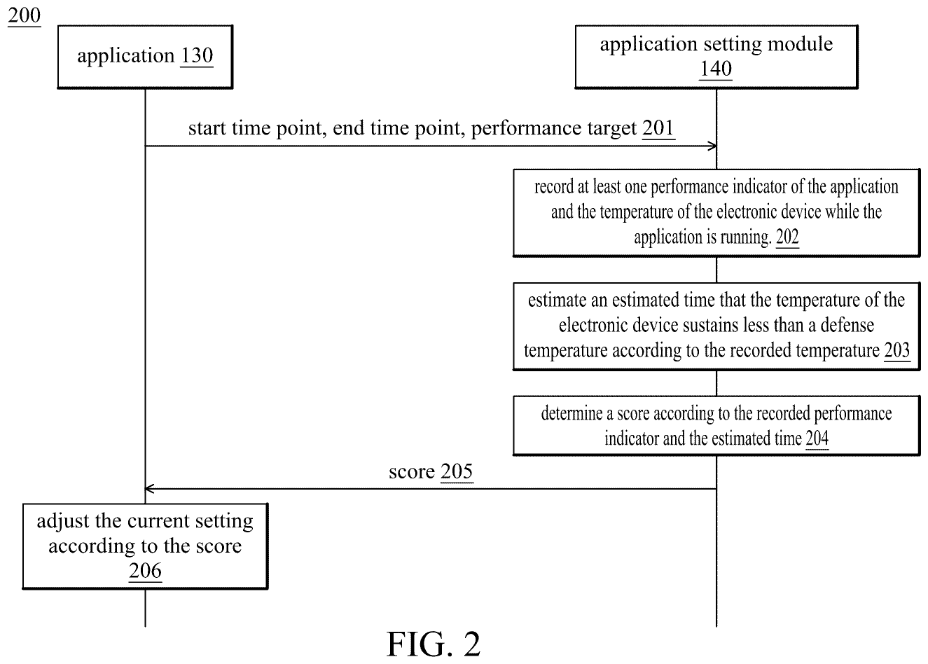

FIG. 2 is a flow diagram of a method 200 for adjusting application settings in accordance with the embodiments of the present disclosure. The method 200 can be performed by the electronic device 100, the application 130, and the application setting module 140. In operation 201, the application setting module 140 receives a start time point, an end time point, and at least one performance target from the application 130. The performance target may be a certain value of frames per second (FPS), minimum FPS, average FPS, standard deviation of FPS, number or duration that the displayed content stops, or power consumption. In some embodiments, the application setting module 140 receives a performance target for power consumption and other performance targets.

In operation 202, the application setting module 140 records at least one performance indicator of the application 130 (e.g. parameter of the application 130) and the temperature of the electronic device 100 while the application 130 is running. In this disclosure, an application is running may refer to that the application is active, being performed by a processor, or interacting with the user. The application setting module 140 records the performance indicator and the temperature from the start time point to the end time point. In other words, the application 130 indicates a certain duration for recording the performance indicator and the temperature using the start time point and the end time point. The performance indicator corresponds to the performance target received in the operation 201. For example, in response to the performance target is FPS, minimum FPS, average FPS, standard deviation of FPS, number or duration that a displayed content stops, or power consumption, the application setting module 140 records FPS, minimum FPS, average FPS, standard deviation of FPS, number or duration that a displayed content stops, or power consumption of the application 130.

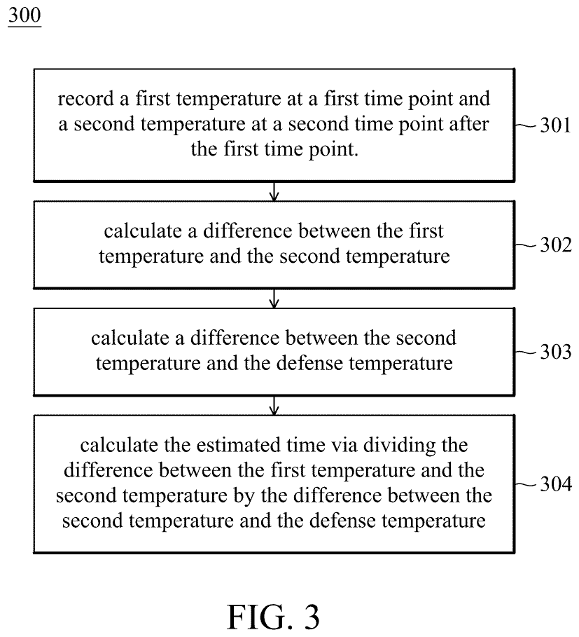

In operation 203, the application setting module 140 estimates an estimated time that the temperature of the electronic device 100 sustains less than a defense temperature according to the recorded temperature. In other words, the application setting module 140 estimates how long the temperature of the electronic device 100 will keep lower than the defense temperature. That is, the application setting module 140 estimates the time that the temperature of the electronic device 100 will become higher than the defense temperature. Refer to FIG. 3, which is a flow diagram of a method 300 for determining the estimated time in operation 203 in accordance with the embodiments of the present disclosure. In operation 301, the application setting module 140 records a first temperature of the electronic device 100 at a first time point and a second temperature of the electronic device 100 at a second time point after the first time point. In some embodiments, application setting module 140 records the temperature of the housing of the electronic device. In some embodiments, the first time point and the second time point are two time points between the start time point and the end time point. In some embodiments, the first time point is the start time point, and the second time point is the end time point.

In operation 302, the application setting module 140 calculates a difference between the first temperature and the second temperature. Specifically, the application setting module 140 calculates the difference between the first temperature and the second temperature by subtracting the first temperature from the second temperature. In operation 303, the application setting module 140 calculates the difference between the second temperature and the defense temperature. Specifically, the application setting module 140 calculates the difference between the second temperature and the defense temperature by subtracting the second temperature form the defense temperature. In operation 304, the application setting module 140 calculates the estimated time by dividing the difference between the first temperature and the second temperature by the difference between the second temperature and the defense temperature.

Overheating will cause frame drop, CPU downclocking, CPU and GPU frequency reduction. Thus, the time that the temperature of the electronic device 100 is under the defense temperature is equivalent to the time that the electronic device 100 (and application 130) can sustain a good performance. By estimating the time that the temperature of the electronic device 100 sustains less than the defense temperature, the application setting module 140 can determine how long the electronic device 100 can sustain a good performance. In some embodiments, the estimated time is longer than the duration between the start time point and the end time point. Estimating the estimated time, instead of measuring the actual time that the temperature of the electronic device 100 become higher than the defense temperature, can allow the electronic device 100 (and the application 130) to take action to prevent a reduction of performance before overheating. In some embodiments, the defense temperature is a temperature under which the electronic device 100 is able to operate without performance reduction (e.g. frame drop, downclocking, frequency reduction).

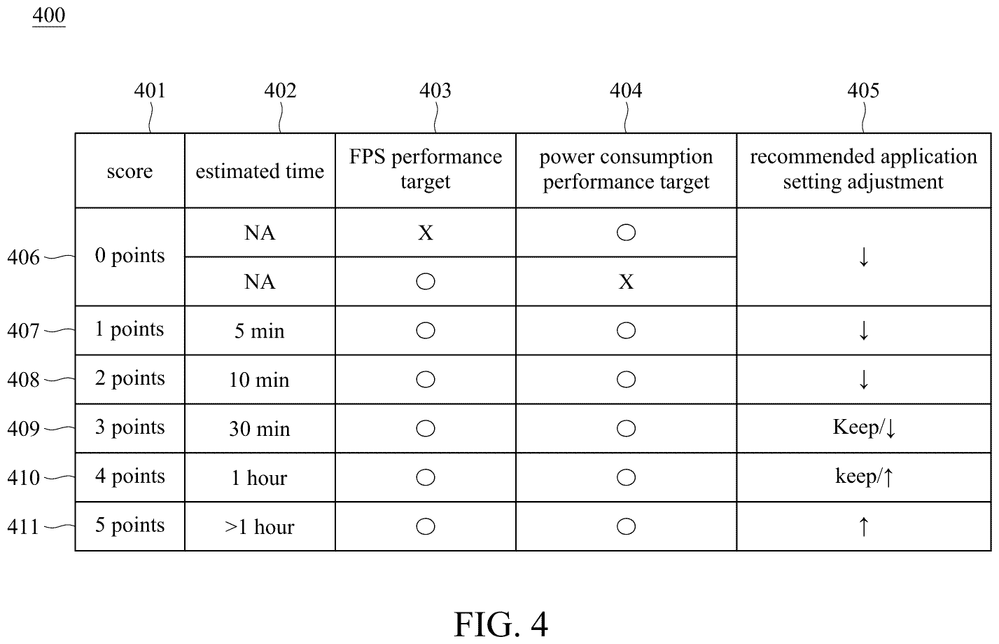

Refer to FIG. 2. After operation 203, the method 200 proceeds to operation 204. In operation 204, the application setting module 140 determines a score according to the recorded performance indicator and the estimated time. The score is configured to indicate the application 130 to raise, lower, or keep a current setting. Refer to FIG. 4, which is an illustration of a table 400 in accordance with the embodiments of the present disclosure. Table 400 shows an illustrative score determination method in operation 204. Column 401 of the table 400 is the determined score. Column 402 of the table 400 is the estimated time calculated in operation 203. Columns 403 and 404 of the table 400 are two different performance targets. In the embodiment shown in FIG. 4, one performance target is FPS, and another performance target is power consumption. Column 405 is the recommended adjustment (keep, raise, or lower) indicated by the score.

As shown in row 406 of the table 400, in response to the recorded performance indicator indicating that any of the performance targets has not been met, the score is 0, and the score indicates the application 130 to lower the current setting. As shown in rows 407˜409 of the table 400, in response to the recorded performance indicator indicating that all of the performance targets are satisfied but the estimated time is shorter than a threshold (30 minutes in this example), the scores are 1˜3, and the scores indicate the application 130 to lower (or keep) the current setting. The longer the estimated time is, the higher the score. As shown in rows 410 and 411 of the table 400, in response to the recorded performance indicator indicating that all the performance targets have been met and the estimated time being longer than a threshold (1 hour in this example), the scores are 4˜5, and the scores indicate the application 130 to keep or higher (maintain or increase) the current setting. The longer the estimated time is, the higher the score.

In this disclosure, the performance target having been met may refer to the recorded FPS, the recorded minimum FPS, or the recorded average FPS being larger than the corresponding performance target, or the recorded standard deviation of the FPS, the recorded number or duration that a displayed content stops, or the recorded power consumption being lower than the corresponding performance target.

Refer to FIG. 2, after operation 204, the method 200 proceeds to operation 205. In operation 205, the application setting module 140 transmits the score to the application 130. In operation 206, the application 130 adjusts (raise, keep, or lower) the current setting according to the score. In this disclosure, raising (lowering) the setting may refer to using a setting which causes a higher (or lower) hardware load or hardware burden. For example, the application 130 changes the FPS, frame rate, graphic quality, visual effects, particle effects, and filters of the image displayed on the screen of the electronic device 100. For example, the current setting of the application 130 is 120 FPS and 1080p. The application 130 may adjusts the current setting to 90 FPS and 1080p, after receiving a 2 points score. For example, the current setting of the application 130 is 60 FPS and 1080p. The application 130 may adjusts the current setting to 90 FPS and 1080p, after receiving a 5 points score.

In some embodiments, the application 130 receives the recorded performance indicator from the application setting module 140 and applies the recorded performance indicator as the new setting. For example, the current setting of the application 130 is 120 FPS. The application 130 may receive the recorded FPS, which is 90, from the application setting module 140. Then, the application 130 may adjust the current setting to 90 FPS. In some embodiments, in operation 206, the application 130 adjusts the current setting according to the score and the user data. For example, the user data may include scenario, habits, and behavior. Moreover, operation 206 can be performed during or outside of user interact.

Embodiments for adjusting application settings are provided. The embodiments of the present disclosure can recommend the application to raise, keep, or lower the setting based on the actual operation of the application. Thus, the embodiments of the present disclosure can automatically find an appropriate setting for the application and improve user experience.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for adjusting application settings, comprising:
receiving, via an application setting module, at least one performance target from an application running on an electronic device;
recording, via the application setting module, at least one performance indicator of the application while the application is running, wherein the performance indicator corresponds to the performance target;
estimating, via the application setting module, an estimated time that a temperature of the electronic device sustains less than a defense temperature; and
determining, via the application setting module, a score according to the performance indicator and the estimated time;
wherein the score indicates the application to raise, lower, or keep a current setting.

2. The method as claimed in claim 1, further comprising:
recording, via the application setting module, the temperature of the electronic device while the application is running;
wherein estimating the estimated time that the temperature of the electronic device sustains less than the defense temperature comprises:
using the application setting module to estimate the estimated time according to the temperature of the electronic device.

3. The method as claimed in claim 2, further comprising:
using the application setting module to receive a start time point and an end time point from the application;
wherein the application setting module records the temperature of the electronic device and the performance indicator of the application from the start time point to the end time point.

4. The method as claimed in claim 2, wherein estimating the estimated time that the temperature of the electronic device sustains less than the defense temperature according to the temperature of the electronic device comprises:
recording, via the application setting module, a first temperature of the electronic device at a first time point and a second temperature of the electronic device at a second time point after the first time point;
calculating, via the application setting module, a difference between the first temperature and the second temperature;
calculating, via the application setting module, a difference between the second temperature and the defense temperature;
calculating, via the application setting module, the estimated time by dividing the difference between the first temperature and the second temperature by the difference between the second temperature and the defense temperature.

5. The method as claimed in claim 1, wherein the score indicates the application to keep or higher the current setting, in response to the performance indicator indicating that the performance target has been met and the estimated time being longer than a threshold.

6. The method as claimed in claim 1, wherein the score indicates the application to keep or lower the current setting, in response to the performance indicator indicating that the performance target has been met and the estimated time is shorter than a threshold.

7. The method as claimed in claim 1, wherein the score indicates the application to lower the current setting, in response to the performance indicator indicating that the performance target has not been met.

8. The method as claimed in claim 1, wherein the performance target comprises frames per second (FPS), minimum FPS, average FPS, standard deviation of FPS, number or duration that a displayed content stops, or power consumption;
wherein the performance indicator comprises FPS of the application, minimum FPS of the application, average FPS of the application, standard deviation of FPS of the application, number or duration that a displayed content stops, or power consumption of the application.

9. The method as claimed in claim 1, further comprising:
transmitting, via the application setting module, the score to the application; and
adjusting, via the application, the current setting according to the score.

10. An electronic device, comprising:
a memory, configured to store at least one program; and
a processor, configured to drive the program to implement an application and an application setting module;
wherein the application setting module is configured to:
receive at least one performance target from the application;
record at least one performance indicator of the application while the application is running, wherein the performance indicator corresponds to the performance target;
estimate an estimated time that a temperature of the electronic device sustains less than a defense temperature; and
determine a score according to the performance indicator and the estimated time;
wherein the score indicates the application to raise, lower, or keep a current setting.

11. The electronic device as claimed in claim 10, wherein the application setting module is further configured to:
record the temperature of the electronic device while the application is running;
estimate the estimated time according to the temperature of the electronic device.

12. The electronic device as claimed in claim 11, wherein the application setting module is further configured to:
receive a start time point and an end time point from the application;
wherein the application setting module records the temperature of the electronic device and the performance indicator of the application from the start time point to the end time point.

13. The electronic device as claimed in claim 11, wherein the application setting module is further configured to:
record a first temperature of the electronic device at a first time point and a second temperature of the electronic device at a second time point after the first time point;
calculate a difference between the first temperature and the second temperature;
calculate a difference between the second temperature and the defense temperature;
calculate the estimated time by dividing the difference between the first temperature and the second temperature by the difference between the second temperature and the defense temperature.

14. The electronic device as claimed in claim 10, wherein the score indicates the application to keep or higher the current setting, in response to the performance indicator indicating that the performance target has been met and the estimated time being longer than a threshold.

15. The electronic device as claimed in claim 10, wherein the score indicates the application to keep or lower the current setting, in response to the performance indicator indicating that the performance target has been met and the estimated time is shorter than a threshold.

16. The electronic device as claimed in claim 10, wherein the score indicates the application to lower the current setting, in response to the performance indicator indicating that the performance target has not been met.

17. The electronic device as claimed in claim 10, wherein the performance target comprises frames per second (FPS), minimum FPS, average FPS, standard deviation of FPS, number or duration that a displayed content stops, or power consumption;
wherein the performance indicator comprises FPS of the application, minimum FPS of the application, average FPS of the application, standard deviation of FPS of the application, number or duration that a displayed content stops, or power consumption of the application.

18. The electronic device as claimed in claim 10, wherein the application setting module is further configured to transmit the score to the application;
wherein the application is configured to adjust the current setting according to the score.
